(19) United States
(12) Patent Application Publication
(10) Pub. No.: US 2010/0013247 A1
(43) Pub. Date: Jan. 21, 2010

(54) Recessed latching device for breakout sliding doors and patio doors

(76) Inventor: Michael Kuchas, Granville, MA (US)

Correspondence Address: Robert L. Rispoli;Clayman, Tapper & Baram, LLC, 3 Regency Drive, Bloomfield, CT, 06002, US

(21) Appl. No.: 12/218,779

(22) Filed: Jul. 18, 2008

(51) Int. Cl. E05B 1/00

(52) U.S. Cl. 292/336.3

(57) ABSTRACT

A recessed latch handle is provided that permits one sliding door to fully open and slide over another sliding door, and it permits a trackless breakout sliding door to fully open in the breakout position. The latch handle is designed with an adjustable hook and it extends from the latch housing rather than the doorjamb. The latching mechanism typically includes at least one flap handle so that one sliding door may fully pass over a second sliding door. The second handle may be a flap handle or an extended handle. The recessed latch handle includes a recessed box, a latching mechanism, a shaft connecting the handles and the latching mechanism, and a means for resistively operating the latching mechanism.

### FIELD OF THE INVENTION

The present invention comprises a locking mechanism for use on breakout sliding doors and patio sliding doors. In particular, a device according to the present invention is designed for use with sliding doors whereby a first door is intended to slide over, and proximate to, a second door. More particularly, the invention relates to a recessed mechanical latching device for use on such doors so that the first door may slide over the entire length of the second door while also providing a robust latching mechanism.

### BACKGROUND OF THE INVENTION

### Brief Description of the Related Art

Hospitals, laboratories, clean room facilities, and other commercial laboratories that use sliding doors and trackless breakout sliding doors have a need for a recessed positive latching device. Current prior art devices include one door comprising an outwardly extending latch mechanism on each side so that the latch mechanism can be engaged by a person on either side of the sliding door. However, the prior art mechanisms do not permit one sliding door to fully open and slide over the other sliding door. The lever-type handle on each side of the door blocks the door panels from opening to the fullest extent. What is needed is a recessed latch mechanism that is fully functional and durable that permits one sliding door to fully open and slide over the other sliding door. Such a device will allow for an increase in the amount of door opening space in an opened sliding position.

Other problems found in the prior art include springs breaking, parts wearing out, latching mechanisms not being able to accommodate a narrow rail doorframe, latching hooks extending from the doorjamb too far and getting caught on clothing or equipment, as well as bulky looking devices that are not aesthetically pleasing.

It is therefore an object of the present invention to overcome these limitations in the prior art. It is another object of the present invention to provide a self-latching device mechanism for use on both trackless breakout sliding doors and patio sliding doors. It is another object of the present invention to provide a recessed latch handle which permits the sliding door to open further than a regular handle.

### DESCRIPTION OF THE INVENTION

The latching device of the present invention comprises a sliding door latching device for both trackless breakout sliding doors and patio sliding doors. In particular, this device comprises a positive sliding door latch with a self-latching mechanism. This latching device is more specifically designed for narrow rail as well as wide rail doorframes. One unique feature of this latching device includes an adjustable latch hook that does not substantially protrude beyond the door frame. This prevents objects from getting caught on the latch hook as such objects pass through the doorway. In addition, the latch housing does not contain any springs that have the potential for breakage. The material selected to fabricate the preferred embodiment of the device provides high durability in given operating conditions.

An additional novel feature of this new design is the latch handle options. In particular, this latching device can accommodate a lever handle as well as a novel recessed latch handle. A recessed latch handle in accordance with the present invention meets the needs of the breakout sliding doors used in commercial buildings and hospitals. This new recessed handle permits the sliding door to open further than a regular lever handle as the two sliding glass panels meet each other in the open position and breakout position.

### BRIEF DESCRIPTION OF THE DRAWINGS

FIG. 1 provides an isometric drawing of a latching device assembly according to the present invention.

FIG. 2 provides an isometric drawing of the latching device shown in FIG. 1 in a disassembled configuration.

FIG. 3A provides a top view of the latching device shown in FIG. 1.

FIG. 3B provides a sectional view of the latching device shown in FIG. 1 taken along line A-A of FIG. 3A.

FIG. 4A provides a sectional view of a door jamb wherein the latching device shown in FIG. 1 is installed within the doorjamb.

FIG. 4B provides a sectional view of the installed latching device shown in FIG. 4A taken along line D-D of FIG. 4A.

### DETAILED DESCRIPTION OF THE INVENTION

A recessed latch handle according to the present invention provides the feature of permitting one sliding door to fully open and slide over the other sliding door. This feature, in turn, provides a trackless breakout sliding door with a wider opening in the breakout position. Prior art latch mechanisms would either interfere with a stationary panel or wall thereby preventing the door from breaking out in a 90 degree position, or the latch itself would extend out into the opening and thereby diminish the amount of space available for items passing therethrough.

A preferred embodiment of the present invention is fabricated from durable aluminum rather than plastic to prevent breakage as well as to prevent wear and tear of parts in the latch housing. Moreover, a latching mechanism according to the present invention does not include any springs which have been found to break with the prior art designs. In contrast, this present invention uses a durable memory rubber component.

The present invention also comprises an adjustable hook that is small and has been designed to extend from the latch housing rather than the door jamb, which allows the door to positively latch without any latching lining up problems, which can be found with other designs. This hook is small enough whereby it does not protrude too far out which prevents objects from catching on the latch as such objects pass through the doorway.

The recessed latch handle also is aesthetically pleasing to homeowners and architects looking for a new latching device that will blend into the doorframe in an unobtrusive way. The device can be powder-coated or anodized to accommodate many colors and thereby match the color of the existing doors.

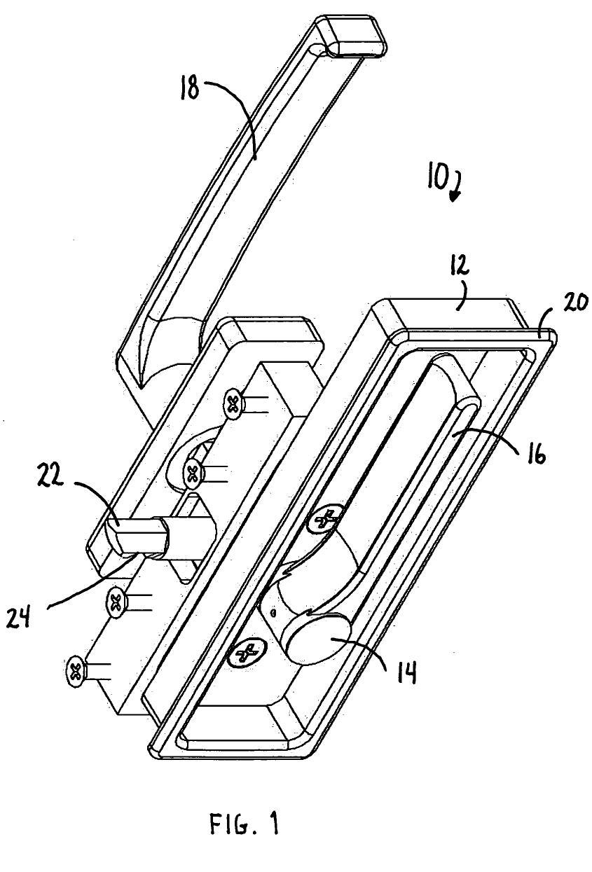

As shown in FIG. 1, the recessed latching mechanism 10 comprises a recessed box 12 that engages a corresponding receiving slot cut out of a sliding door. Recessed box 12 comprises set flange 20 positioned within the latch rail of the door. A latching mechanism 14 with flap handle 16 is positioned within recessed box 12. Installed on the other side of a sliding door is either a conventional latching mechanism and extended handle 18 or another latching mechanism 14.

Recessed latching mechanism 10 further comprises adjustable latch hook 22 which, in turn, defines notch 24 for mating with the doorjamb strike. In operation, flap handle 16 is pressed or pulled away from the door jamb thereby raising latch hook 22 such that notch 24 no longer engages the door jamb strike and the door may slide freely into an open position. In a preferred embodiment of the present invention, notch 24 engages the door jamb strike with a 0.125 inch drop and flap handle 16 is pressed or pulled away from the doorjamb thereby raising latch hook 22 by 0.25 inch such that notch 24 completely clears the door jamb strike.

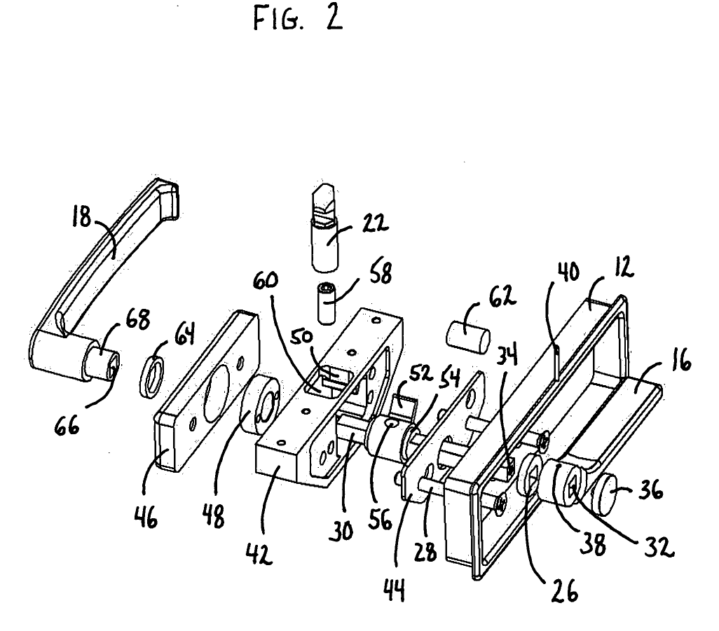

The assembly of recessed latching mechanism 10 is depicted in FIG. 2. Recessed box 12 houses flap handle 16, offset 26, and one end of fasteners 28. Offset 26 is designed to keep flap handle 16 from rubbing the inside face of recessed box 12. Shaft 30 runs from a first latching handle, in this embodiment flap handle 16, through the recessed latching mechanism 10, to a second latch handle, in this embodiment latch handle 18.

Flap handle 16 defines aperture 32 designed to receive shaft 30. Shaft 30 extends through recessed box 12, offset 26, and flap handle 16. Shaft 30 defines an aperture 34 on its top designed to receive end cap 36. Flap handle 16 further defines aperture 38 designed to receive set pin 40; both of which operate to keep flap handle 16 fixedly engaged with shaft 30.

Recessed latching mechanism 10 further comprises latch housing 42, latch housing cover plate 44, a protective plate or scutcheon 46 and scutcheon insert 48. As shown, latch housing 42 is designed to receive latch housing cover plate 44, and scutcheon 46 is designed to receive scutcheon insert 48. Latch housing 42 further defines machined protrusion or seat 50 designed to resistively engage the front face of protrusion 52 of latch cylinder 54. Memory plug 62 is positioned within latch housing 42 and is designed to resistively engage the rear face of protrusion 52. In a preferred embodiment of the invention, memory plug 62 is fabricated from rubber.

Threaded set screw 58 passes through aperture 60 in latch housing 42 and threadedly engages aperture 56 of latch cylinder 54. Adjustable latch hook 22 threadedly engages set screw 58. In a preferred embodiment of the invention, threaded set screw 58 defines an outer thread to engage an inner thread defined in aperture 56 of latch cylinder 54. Similarly, set screw 58 defines an outer thread to engage an inner thread defined in latch hook 22.

Completing the assembly depicted in FIG. 2, handle 18 defines aperture 66 designed to receive shaft 30. Further, handle 18 is designed to threadedly engage scutcheon insert 48. Preferably, surface 68 defines an outer thread and scutcheon insert 48 defines an inner thread. Bushing 64 is positioned between handle 18 and 46 to reduce friction between handle 18 and scutcheon 46. The assembly including handle 18, bushing 64, scutcheon 46, and scutcheon insert 48 are mounted to the opposing handle configuration with fasteners 28.

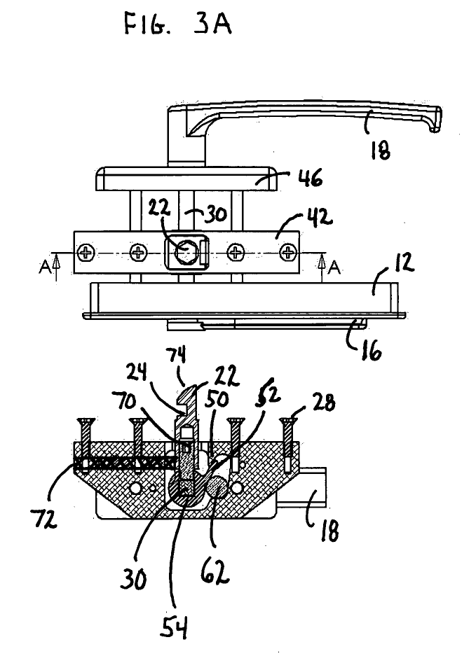

Additional assembly and benefits of the device are shown in FIG. 3A and FIG. 3B. Latch hook 22 defines a hexagonal periphery to engage a socket driver for ease of removal or readjustment. Flap handle 16 extends outwardly from recessed box 12 in order to provide additional fingertip gripping surface. In a preferred embodiment of the invention, threaded set screw 58 defines aperture 70 designed to receive an alien wrench for ease of assembly when threadedly engaging latch cylinder 54. Set screw 72 can be adjusted to provide corresponding adjustment to the pitch of latch hook 22. In addition, the top face or striking face 74 of latch hook 22 defines a larger draft to accommodate an increased draft for strike.

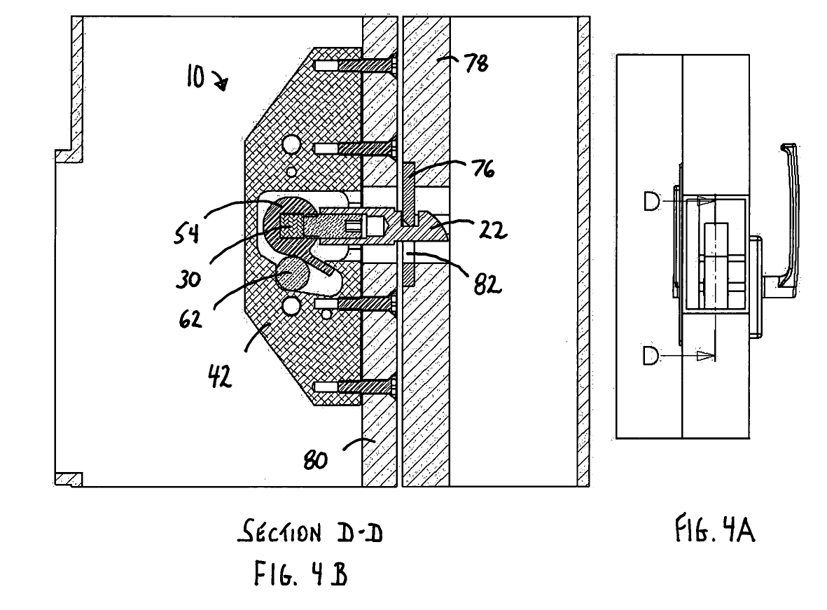

FIG. 4A and FIG. 4B depict the recessed latching mechanism 10 according to the present invention in combination with a strike plate 76 of a door frame 78. Sliding door 80, in which the recessed latching mechanism is installed, is in the closed position. As best shown in FIG. 2, when flap handle 16 is pressed away from the door jamb in the present embodiment, shaft 30 is rotated clockwise. Correspondingly, latch cylinder 54 is rotated clockwise. As best shown in FIG. 4B, latch hook 22 is raised within aperture 82 of door frame 78 in order to clear strike plate 76. After latch hook 22 clears strike plate 76, memory plug 62 pushes latch cylinder 54, and in turn, shaft 30 and flap handle 16, back into their stationary positions.

Devices according to this invention may be used alone or in conjunction with automatic sliding door closing devices for trackless breakout sliding doors and patio sliding door closer devices. The alignment of the positive latching feature accommodates the automatic self-closing devices found in hospitals with respect to Intensive Care Unit doors, clean room facilities, fire doors, and laboratories. This positive latching device also may be used with the automatic closing device used on the patio sliding doors for energy efficiency, convenience, security, and safety of having a patio sliding door automatically closed and latched.

As one will readily determine, a recessed latching mechanism according to the present invention is extremely easy to use with just a slight finger touch thereby making it very convenient. Another embodiment of the present invention will accommodate a regular latch handle if so desired. Typically, a device according to the present invention is machined into the door on site but also could be machined into the door at the factory. Machining the latching device into the door allows for better alignment of the positive latching feature.

The latching mechanism of the present invention overcomes the shortcomings of the prior art. Although the invention has been described in considerable detail with respect to particular embodiments of Applicant's latching mechanism, it will be apparent that the invention is capable of numerous modifications and variations, apparent to those skilled in the art, without departing from the spirit and scope of the invention.

1. A recessed latching device comprising:
a) a recessed box;
b) a latching mechanism;
c) a first handle mechanically attached to the latching mechanism;
d) a second handle mechanically attached to the latching mechanism; and
e) an elongated shaft mechanically connected to the latching mechanism, the first handle and the second handle.

2. The recessed latching device of claim 1 wherein the latching mechanism further defines a means for engaging a door jamb.

3. The recessed latching device of claim 2 wherein the means for engaging a doorjamb is released by operating the first or second handle.

4. The recessed latching device of claim 3 wherein the means for engaging a door jamb is automatically engaged when it strikes the door jamb.

5. The recessed latching device of claim 4 wherein the first handle comprises a flap handle.

6. The recessed latching device of claim 5 wherein the second handle comprises an extended handle.

7. The recessed latching device of claim 5 wherein the second handle comprises a flap handle.

8. The recessed latching device of claim 5 wherein the flap handle further defines:
a) a first end for receiving one end of the shaft;
b) a first aperture in the first end for receiving one end of the shaft; and
c) a second aperture in the first end for receiving a set pin wherein the set pin engages a corresponding aperture in the shaft.

9. The recessed latching device of claim 8 wherein the latching device further comprises:
a) a latch housing;
b) a latch housing cover plate;
c) a protective plate;
d) a latch cylinder defining a protrusion thereon; and
e) at least one fastening device.

10. The recessed latching device of claim 9 wherein the latch housing further comprises a protrusion for engaging a front face of the protrusion of the latch cylinder.

11. The recessed latching device of claim 10 further comprising an insert for engaging a rear face of the protrusion of the latch cylinder.

12. The recessed latching device of claim 9 wherein the latch housing further comprises a means for resistively engaging the latch cylinder.

13. The recessed latching device of claim 11 wherein:
a) the latching mechanism further defines a first setting mechanism;
b) the latch housing defines an aperture for receiving the first setting mechanism;
c) the latch cylinder defines an aperture for receiving the first setting mechanism; and
d) the first setting mechanism is mechanically connected to a latch hook.

14. The recessed latching device of claim 13 further comprising a second setting mechanism for adjusting the pitch of the first setting mechanism.

15. The recessed latching device of claim 11 further comprising a means for setting the depth of the latching mechanism.

16. The recessed latching device of claim 15 further comprising a means for setting the pitch of the latching mechanism.

17. A recessed latching device comprising:
a) a recessed box;
b) a latching mechanism;
c) a first handle mechanically attached to the latching mechanism;
d) a second handle mechanically attached to the latching mechanism;
e) an elongated shaft mechanically connected to the latching mechanism, the first handle and the second handle;
f) a means for engaging a door jamb and disengaging from the door jamb; and
g) a means for resistively operating the latching mechanism.
